(19) United States
(12) Patent Application Publication
(10) Pub. No.: US 2008/0198145 A1
(43) Pub. Date: Aug. 21, 2008

(54) ACOUSTIC WAVE TOUCH ACTUATED SYSTEM

(76) Inventors: Terrence J. Knowles, Barrington, IL (US); Charles F. Bremigan, Jarrell, TX (US); Wayne J. Wehrer, Austin, TX (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/946,251

(22) Filed: Nov. 28, 2007

Related U.S. Application Data
(60) Provisional application No. 60/902,278, filed on Feb. 20, 2007.

(51) Int. Cl. G06F 3/043

(52) U.S. Cl. 345/177

(57) ABSTRACT

A touch pad assembly includes a substrate and a plurality of acoustic wave switches positioned with respect to the substrate. Each of the plurality of acoustic wave switches includes a touch surface connected to an acoustic wave cavity and a transducer secured to the acoustic wave cavity. The plurality of acoustic wave switches are positioned to provide detection of sliding motion direction and rate between the plurality of acoustic wave switches.

### RELATED APPLICATIONS

This application relates to and claims priority benefits from U.S. Provisional Patent Application No. 60/902,278 entitled “Acoustic Wave Touch Actuated System,” filed Feb. 20, 2007, which is hereby incorporated by reference in its entirety.

### FIELD OF THE INVENTION

Embodiments of the present invention generally relate to an acoustic wave touch actuated system and more particularly to an acoustic wave touch actuated system that may be used to detect motion, including direction and speed, over a surface of a device.

### BACKGROUND OF THE INVENTION

Capacitive slider assemblies and laptop computer touch or mouse pads are currently configured to detect sliding motion. For example, an operator may slide a finger across the touch or mouse pad, and a processing unit within the laptop correlates that motion with respect to images shown on the screen of the laptop computer. Thus, as a user moves a finger over the touch or mouse pad, a cursor displayed on the screen may move in response to the movement of the finger over the touch or mouse pad.

Typically, touch or mouse pads and capacitive slider assemblies use capacitive sensors to detect a touch and corresponding movement. For example, a conventional touch or mouse pad includes a plurality of capacitive sensors to detect movement across the pad. However, capacitive sensors may be adversely affected by water or other such fluids on the surface of the touch or mouse pad. Additionally, conventional capacitive sensors are not able to distinguish between pressure levels. That is, a finger pressed into a conventional touch pad at a first force is detected the same as a finger pressed into the conventional touch pad at a second force.

### SUMMARY OF THE INVENTION

Embodiments of the present invention provide an improved system and method of detecting pressure and movement over a surface, such as may be used, for example, with respect to a computer (e.g., a touch or mouse pad of a laptop computer), and various other applications.

Certain embodiments of the present invention provide a touch pad system that may include a sensing device (such as a processing unit and/or sensing circuit), a substrate and a plurality of acoustic wave switches. The plurality of acoustic wave switches are positioned with respect to the substrate, with each of the acoustic wave switches including a touch surface connected to an acoustic wave cavity and a transducer secured to a side of the acoustic wave cavity that may be opposite the touch surface. The sensing device is in communication with each transducer. The plurality of acoustic wave switches are positioned to provide detection of sliding motion direction and rate between the plurality of acoustic wave switches. Adjacent acoustic wave switches are positioned close enough with respect to one another so that a finger tip touches both at the same time during operation.

The acoustic wave switches may be oriented in a linear fashion, arranged in a circle, arranged in a plurality of rows, or various other configurations. The plurality of acoustic wave switches may be arranged in rows and columns on the substrate, wherein the rows and columns intersect to form the touch surfaces.

The plurality of acoustic wave switches may include four acoustic wave switches arranged as a cross, wherein a finger overlays a portion of each of the four acoustic wave switches during operation. A user may then shift the finger over the four acoustic wave switches. The detected changes in amplitude, impedance, resonant frequency or decay rate of the acoustic wave switches is used to determine movement of the finger over the four acoustic wave switches.

The sensing device receives signals from the plurality of acoustic wave switches such that varying touch pressures are capable of being distinguished. For example, the transducer generates an acoustic wave that is trapped in the acoustic wave cavity. A touch on the touch surface absorbs the wave energy and changes the amplitude, decay rate, impedance or resonant frequency. The detected change depends on the amount of pressure (i.e., force exerted by a touch) applied to the touch surface.

Certain embodiments of the present invention also provide a touch pad system that includes one or both of a processing unit and/or a sensing circuit, and first and second acoustic wave switches. The acoustic wave switches are spaced from one another such that a finger may contact both of the acoustic wave switches simultaneously. The processing unit and/or the sensing circuit recognizes a touch on the first acoustic switch as a first value, a touch on the second acoustic wave switch as a second value, and a touch on both of the first and second acoustic wave switches simultaneously as a third value. The first, second and third values are correlated to a position of a finger on the touch pad system.

### BRIEF DESCRIPTION OF SEVERAL VIEWS OF THE DRAWINGS

FIG. 1 illustrates a top plan view of a linear slider pad according to an embodiment of the present invention.

FIG. 2 illustrates a side cross-sectional view of an acoustic wave switch according to an embodiment of the present invention.

FIG. 3 illustrates a top plan view of a circular slider according to an embodiment of the present invention.

FIG. 4 illustrates a top plan view of touch pad having an array of acoustic wave switches according to an embodiment of the present invention.

FIG. 5 illustrates a top plan view of an acoustically multiplexed touch screen pad according to an embodiment of the present invention.

FIG. 6 illustrates a substrate supporting a densely packed array of acoustic wave switches according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

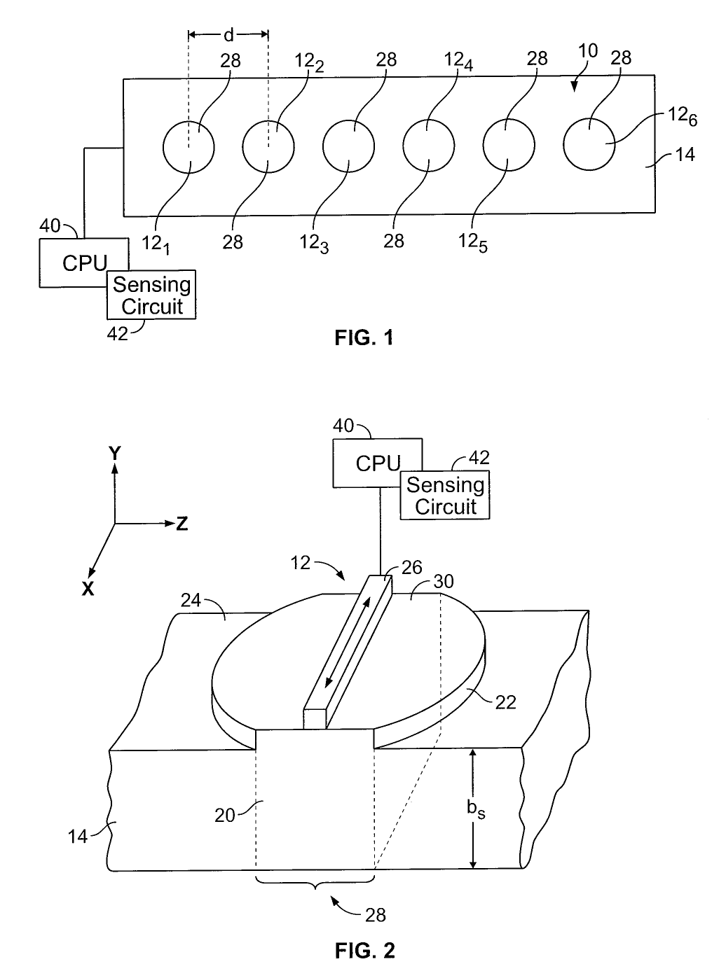

FIG. 1 illustrates a top plan view of a linear slider pad 10 according to an embodiment of the present invention. The slider pad 10 includes a plurality of acoustic wave switches 12 formed on or within a substrate 14. Each acoustic wave switch 12 may include respective indicia that identifies the position of a particular switch 12. The substrate 14 and the acoustic wave switches 12 may be formed of any material such as metal, plastic, glass, ceramic, or the like, in which an acoustic wave may propagate.

FIG. 2 illustrates a side cross-sectional view of an acoustic wave switch 12. Each acoustic wave switch 12 has an associated acoustic wave cavity, or resonator 20 that extends through the thickness bₛ of the substrate 14. The acoustic wave cavity 20 is formed in the substrate 14 such that the mass per unit surface area of the acoustic wave cavity 20 is greater than the mass per unit surface area of the substrate 14 adjacent the acoustic wave cavity 20. In one embodiment, the mass per unit area of the substrate in the switch region is increased to form the acoustic wave cavity 20 by forming a thin plateau or mesa 22 on a surface of the substrate 14 that is parallel to the plane of the substrate 14 and/or a touch surface 28. The mesa 22 may be formed on a back surface 24 of the substrate opposite the touch surface 28 of the acoustic wave cavity 20. Alternatively, the mesa 22 may be formed on the touch surface 28. A transducer 26 may be mounted on a surface 30 of the acoustic wave cavity 20 to generate an acoustic wave that is substantially trapped or localized in the acoustic wave cavity 20. Although the transducer 26 is shown as mounted on the mesa 22, if the mesa 22 is formed on the touch surface 28 of the substrate, the transducer 26 may be mounted directly on the substrate surface of the acoustic wave cavity 20 opposite the mesa 22 so that the transducer 26 is on the backside of the substrate 14. Each transducer 26 of each acoustic wave switch 12 is electrically connected to a processing unit 40 and/or a sensing circuit 42.

Each acoustic wave switch 12 may use any type of acoustic wave capable of being substantially trapped in a particular acoustic wave cavity 20. For simplicity, the acoustic wave switch 12 is described using a shear wave in a direction that is in the plane of the substrate 14, wherein the shear wave energy extends in a direction perpendicular to the plane of the substrate 14, that is, through the thickness of the substrate 14. A shear wave is advantageous because it is insensitive to liquids and other contaminants on the touch surface 28 of the acoustic wave switch 12. Because the fundamental or zeroth order mode of a horizontally polarized shear wave may not be substantially trapped, higher order shear wave modes are used in accordance with embodiments of the present invention. It should be appreciated that because the acoustic wave used is trapped, the wave is a standing wave. A standing wave has a number of advantages over an acoustic wave that propagates or travels along a path in a substrate. For example, propagating waves are not confined to the main path of propagation but can diffract off of the main path complicating touch detection. This is opposed to a standing wave which by its nature is confined to the area of a particular acoustic wave cavity 20. Because the acoustic wave is confined, touch detection is easily accomplished. Further, the wave energy of a propagating wave is not stored at any location along the path. Once the wave passes a point along the path, the wave is gone, thereby making timing and control critical for touch detection with propagating waves. There are no timing or control issues with a standing wave because the wave energy is stored in the particular acoustic wave cavity 20. Moreover, a propagating wave is not a resonating wave. As such, the wave energy decays as it travels. A standing wave is resonant so that the wave is reinforced and prolonged. As a result, the standing wave has a much greater amplitude than a wave that is not confined. The construction and operation of each acoustic wave cavity 20 is further described in U.S. Pat. No. 7,106,310, entitled “Acoustic Wave Touch Actuated Switch” (The “'310 patent”), which is hereby incorporated by reference in its entirety.

Embodiments of the present invention provide a system and method of detecting pressure and movement with respect to a surface, such as a mouse pad, dial, keypad, or the like, using active touch that employs trapped energy concepts to create localized mechanical resonators, or acoustic wave cavities 20. The '310 patent discloses an acoustic wave switch that includes a substrate with an acoustic wave cavity, or resonator, formed therein such that the mass per unit area of the acoustic cavity is greater than the mass per unit area of the substrate adjacent the acoustic cavity. A transducer is mounted on the acoustic cavity for generating an acoustic wave that is substantially trapped in the cavity. A touch on the touch surface of the acoustic cavity absorbs acoustic wave energy and produces a detectable change in the impedance of the transducer. Moreover, as a user touches the touch surface, the resonant frequency changes, which may be detected by a processing unit which is electrically connected to the transducer.

The acoustic wave switch described in the '310 patent has a high Q (the ratio of the stored energy to lost or dissipated energy over a complete cycle) so as to enable a touch to be detected by extremely simple, low-cost circuitry. The acoustic wave switch is rugged, explosion proof, operates in the presence of liquids and other contaminants (unlike capacitive sensors), has a lower power consumption and may be incorporated and integrally formed in a wall of a housing for a device.

With respect to FIGS. 1 and 2, each acoustic wave switch 12 may be connected to an extremely simple touch detection or sensing circuit 42, such as shown and described in the '310 patent. For example, each transducer 26 associated with a respective acoustic wave switch 12 may be coupled to a multiplexer that sequentially couples the transducer 26 and its associated acoustic wave switch 12 to an oscillator, as discussed in the '310 patent. Embodiments of the present invention may detect a touch on a respective touch surface 28 through a detected change in impedance, as described in the '310 patent.

Optionally, embodiments of the present invention may detect a touch on a respective touch surface 28 by measuring the decay time of the acoustic wave within a particular acoustic wave cavity 20. United States Patent Application Publication No. 2004/0246239, entitled “Acoustic Wave Touch Detection Circuit and Method” (the “'239 application”) which is hereby incorporated by reference in its entirety, describes a controller that detects a sensed event such as a touch on an acoustic wave switch/sensor based on the decay time. The trapped acoustic wave within the acoustic cavity, or resonator, acts to “ring” the acoustic cavity. That is, as a voltage is applied to transducer, the transducer operates to resonate the acoustic cavity.

As described in the '239 application, the sensing circuit 42 operatively connected to an acoustic wave switch 12 may include a controller that drives the transducer 26 to generate a resonant acoustic wave in the acoustic wave cavity 20 during a first portion of a sampling cycle. In a second portion of the sampling cycle, the controller monitors the time that it takes for the acoustic wave signal from the transducer 26 to decay to a predetermined level. Based on the decay time, the controller detects a sensed event, such as a touch on the touch surface 28 of the acoustic wave switch 12.

Referring to FIGS. 1 and 2, the acoustic wave switches 12 formed on or within the substrate 14 of the linear slider pad 10 may be formed and operate as those shown and described in either the '310 patent or the '239 application. That is, instead of using capacitive sensors, each circular touch surface 28 of each acoustic wave switch 12 is connected to, or part of, an acoustic wave cavity 20 or resonator operatively connected to a transducer 26, as shown in FIG. 2. While the touch surfaces 28 are shown as circles, the shape and size of each touch surface 28 may be different than shown in FIGS. 1 and 2.

It has been discovered that acoustic wave switches 12 may be positioned close together on a substrate 14 without adversely affecting one another. The acoustic wave switches, or resonators 12 may be positioned close enough such that, during use, a finger or glove will be in contact with at least two acoustic wave switches 12 at a given time. The distance d between two acoustic wave switches 12 is small enough to ensure that a finger tip or glove tip will be in contact with at least two acoustic wave switches 12 during operation, thereby providing, by signal interpolation, a response from discrete sensors operatively connected to the transducers 26 that is continuous along a line of acoustic wave switches 12. For example, the acoustic wave switches 12₁ and 12₂ may be less than ⅛″ from one another. As noted above, the processing unit 40 and/or sensing circuit 42 is operatively connected to each transducer 26. As such, the processing unit 40 and/or the sensing circuit 42 are able to detect which acoustic wave switches 12 are being touched. Therefore, the processing unit 40 and/or the sensing circuit 42 are able to determine which direction the touching medium, e.g., a finger tip, is moving and how fast it is moving over the linear slider pad 10.

As a finger tip moves from left to right over the first two acoustic wave switches 12₁ and 12₂, the detected impedance or rate of acoustic decay of the first two acoustic wave switches 12₁ and 12₂ changes as the finger tip moves from left to right. For example, at time t₁, a majority of a surface area of a user's finger tip may be over the acoustic wave switch 12₁, while a smaller portion is over the acoustic wave switch 12₂. As such, the processing unit 40 and/or sensing circuit 42 detects a first impedance or rate of decay with respect to the acoustic wave switch 12₁ that is different than the detected impedance or rate of decay with respect to the acoustic wave switch 12₂. At time t₂, as the user moves the finger from left to right, a majority of the surface area of the user's finger shifts over the acoustic wave switch 12₂, while a smaller portion is over the acoustic wave switch 12₁. Thus, at time t₂, the detected impedance or rate of decay with respect to the acoustic wave switches 12₁ and 12₂ is different than at time t₁. The processing unit 40 and/or sensing circuit 42 detects the change in impedance or rate of decay from time t₁ to time t₂ with respect to both acoustic wave switches 12₁ and 12₂. These impedance or rate of decay changes with respect to the acoustic wave switches 12 is correlated to directional movement and rate of movement. That is, as the detected impedances or rates of decay with respect to adjacent acoustic wave switches 12 change, the processing unit 40 and/or the sensing circuit 42 correlate the detected changes to directional movement and rate of movement.

For example, if the processing unit 40 and/or sensing circuit 42 detects a first set of changes of impedance or rate of decay for acoustic wave switches 12₁ and 12₂, the processing unit 40 and/or sensing circuit 42 determines that a touching medium, e.g., a finger, is moving in a first direction at a first rate. If the rate of change of impedance or rate of decay with respect to the acoustic wave switches 12₁, and 12₂ varies, then the processing unit 40 and/or sensing circuit 42 determines that the finger is moving from left to right, or right to left, at a different rate. In general, touch detection algorithms may be adapted so that pressure variable responses result in continuous or discrete level pressure sensors.

With respect to acoustic decay, for example, as the touch surface 28 of an acoustic wave switch 12 is touched, acoustic wave energy is absorbed by the touch. Thus, the resonance of the acoustic wave within the acoustic wave cavity 20 decays. The time of the decay is correlated to a threshold voltage and the processing unit 40 counts the number of cycles it takes between the transducer 26 “striking” the acoustic wave cavity 20 and the particular decayed level. When the acoustic wave switch 12 is touched, the acoustic wave cavity 20 rings down faster and the threshold voltage occurs at a smaller count. Thus, the measure of whether the acoustic wave cavity 12 has been touched or not is based on the count. As a finger is slid over the acoustic wave switches 12 on the substrate 14, the acoustic wave switch 12 that the finger is leaving will be dampened less, and the acoustic wave switch 12 toward which the finger is moving will be dampened more (as such, the count for that pad will be decreasing because of the increased dampening). The processing unit 40 and/or the sensing circuit 42 detect the dampening changes and correlate that to directional movement and rate of movement over the linear slider pad 10.

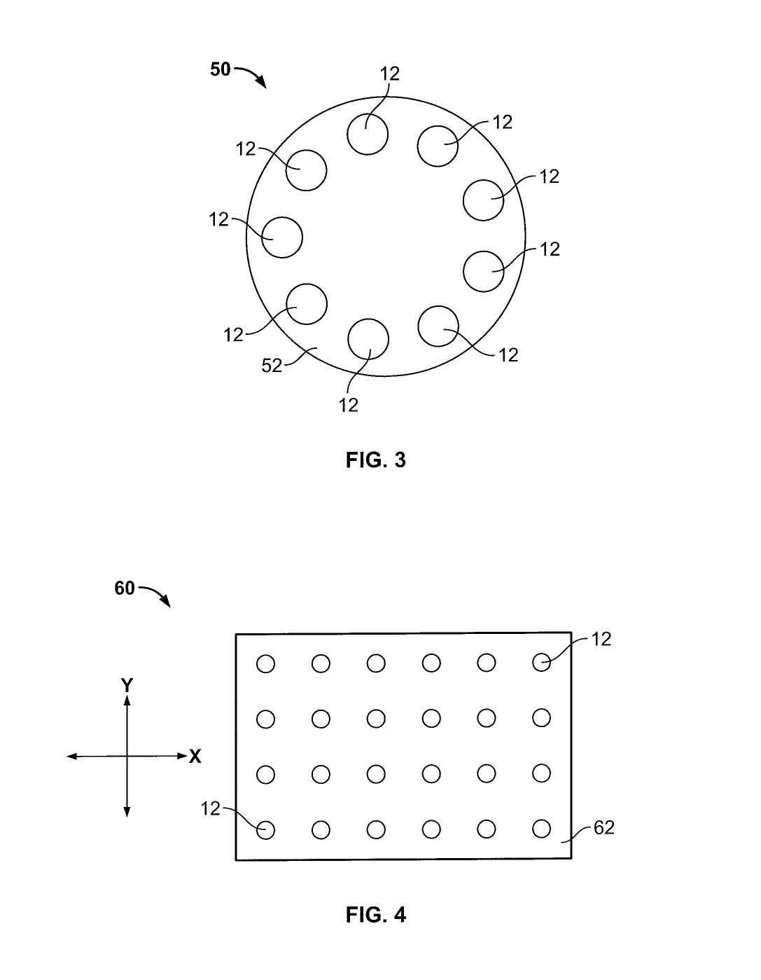

FIG. 3 illustrates a top plan view of a circular slider 50 according to an embodiment of the present invention. The circular slider 50 includes a substrate 52 with a plurality of acoustic wave switches 12 positioned on or within the substrate in a circular pattern. The circular slider 50 is similar to the linear slider pad 10 (shown in FIG. 1), except that the acoustic wave switches 12 are oriented in a circular pattern. Similar to the linear slider pad 10, adjacent acoustic wave switches 12 are spaced close enough together so that, during use, a touching medium contacts two acoustic wave switches at any one time. The circular slider 50 may be used as a dial. That is, a user may slide a finger over the acoustic wave switches 12 in a circular pattern. The circular slider 50 may be connected to a processing unit and/or a sensing circuit, as discussed above, which correlate changes in amplitude, impedance or decay rates with respect to the acoustic wave switches 12 to directional movement and rate of movement, similar to that discussed above. When a finger touches two adjacent switches 12 at the same time, thereby activating both switches 12, this may be recognized as an additional touch position. For example, during this contact, the processing unit detects that two switches 12 are activated. The slider assembly shown in FIG. 3, for example, may operate as a discrete switch control interface with, for example, twenty positions, but with only ten switches 12 by such an interpolation technique. For example, a first switch being touched yields a first value, while a second switch being touched yields a second value. Additionally, both the first and second switch being touched at the same time yields still another value.

FIG. 4 illustrates a top plan view of touch pad 60 having an array of acoustic wave switches 12 according to an embodiment of the present invention. The acoustic wave switches 12 are positioned on a substrate 62 and may be non-multiplexed. The touch pad 60 is a mouse-type acoustic wave sensor system that utilizes two dimensional tracking in the x and y directions. Four rows of six acoustic wave switches 12 may be used. However, embodiments of the present invention may include more or less than those shown. The touch pad 60 may include nine or more acoustic wave switches 12 per square inch. The acoustic wave switches 12 are operatively connected to a processing unit and/or a sensing circuit, as discussed above.

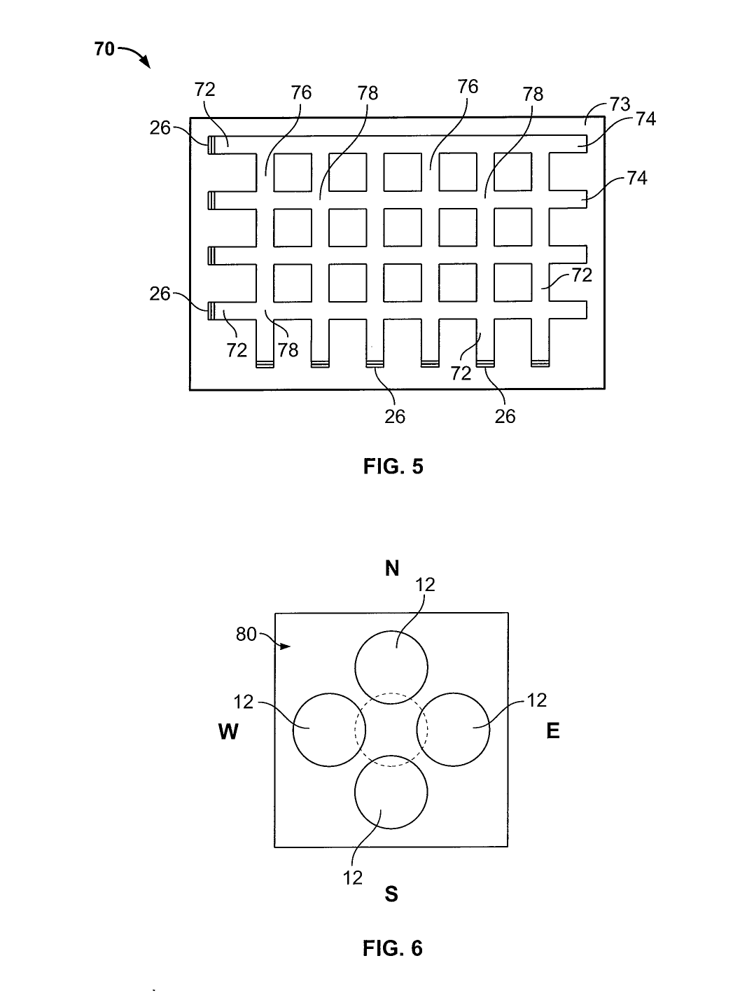

FIG. 5 illustrates a top plan view of an acoustically multiplexed touch screen pad 70 according to an embodiment of the present invention. Raised acoustic wave switches or resonators 72 are positioned on, or formed over, a substrate 73. As shown in FIG. 5, the acoustic wave switches 72 are aligned on or over the substrate 73 such that the planes of the acoustic wave switches 72 and the substrate 73 are parallel with one another. Each acoustic wave switch 72 includes a transducer 26 coupled to one end. Four rows 74 of acoustic wave switches 72 intersect six columns 76 of acoustic wave switches 72. Optionally, more or less rows 74 and columns 76 may be used than those shown.

The intersections of the rows 74 and columns 76 of acoustic wave switches 72 form touch surfaces 78. Movement over each of the touch surfaces 78 is detected by the horizontally and vertically aligned transducers 26. Thus, less transducers 26 are needed (as compared to a non-multiplexed arrangement) due to the fact that changes will be detected by a combination of transducers 26 at the ends of the raised acoustic wave switches 72. For example, a finger positioned at a touch surface 78 represented by the intersection of the lowest row 74 and the leftmost column 78 produces a first impedance and/or decay that is detected by the transducer 26 of that row 74, while a second impedance and/or decay is detected with respect to the transducer 26 of the column 76. If the finger is moved, the detected impedances or acoustic decays with respect to the respective transducers changes accordingly. Each acoustic wave switch 72 is operatively connected to a processing unit and/or sensing circuit, as discussed above.

FIG. 6 illustrates a substrate 80 supporting a densely packed array of acoustic wave switches 12 according to an embodiment of the present invention. As shown in FIG. 6, the acoustic wave switches 12 are positioned at “North,” “South,” “East” and “West” positions.

As shown in FIG. 6, four acoustic wave switches 12, for example, are formed close together in the shape of a cross. A touching medium, such as a finger tip, glove tip, absorbing rubber ball, or the like, may span all four acoustic wave switches 12, and roll in a desired cursor direction. Consider two acoustic wave switches 12 of the cross, aligned along a N-S axis for example, and assume a finger tip placed at the center of the cross rolls to the Northwest thereby applying more pressure to the North and West acoustic wave switches 12 and less on the South and East. By comparing the North acoustic wave switch 12 response to the South acoustic wave switch 12 response, a N-S axis signal is generated. The same comparison is done between the E-W pair of acoustic wave switches 12, and the signals are vectorially added. As such, a simple cursor control system is created that can be operated by finger tip. An absorbing overlay may be positioned over each acoustic wave switch 12 in order to make the sensor assembly act as a trackball or joystick. Pressure sensitivity may be utilized for both selection and speed determination of the cursor. The surface region that includes the four acoustic wave switches 12 may be contoured for optimum ergonomics.

During operation, a user positions a finger on the substrate 80 over the acoustic wave switches 12 or pads. That is, the finger overlays portions of each one of the acoustic wave switches 12. As the user shifts finger pressure from the “West” and “South” acoustic wave switches 12 to the “East” and “South” pads, the impedances of the transducers and/or the measured rates of acoustic decay change accordingly. These changes are correlated to directional movement and rate of movement by a processing unit and/or sensing circuit to which the acoustic wave switches 12 are operatively connected.

The acoustic wave cavity or resonator pads, rows, or columns shown and described with respect to FIGS. 1-6 are touch sensitive with a response that varies with touch pressure from fingers, gloves and absorbing materials. Each of the resonator pads, rows, or columns shown in FIGS. 1-6 may be similar to the acoustic wave cavities shown and described with respect to the '310 patent and the '239 application. Touch detection algorithms may be adapted so that pressure variable responses result in continuous or discrete level pressure sensors.

The signal processing techniques described above are analogous to those used in capacitive slider and mouse applications. The mouse pad in a laptop computer, as noted above, includes a series of capacitive sensors having circuit board traces in both horizontal and vertical directions and uses interpolation to create a smooth response.

A linear and circular resonator sensor system, such as shown in FIGS. 1 and 3, may include, for example, three to six resonators or acoustic wave switches per linear inch. Additionally, as noted above, the mouse type resonator sensor system such as shown in FIG. 4, which utilizes two dimensional tracking, may include, for example, nine resonators per square inch. The acoustic multiplexing system, as shown in FIG. 5, may utilize six raised resonators per square inch.

Active touch sensing, as described in the '310 patent and the '239 application and used with the embodiments described with respect to FIGS. 1-6, has several operational advantages over capacitive sensors. First, the pressure sensitivity of the acoustic wave switches or resonators may be used to direct a cursor to a location using a slight sliding motion, then increasing the finger pressure to activate. For example, a user may exert a slight amount of pressure over the acoustic wave switches of the embodiments shown in FIGS. 1-6 to move a cursor over a screen. When the user moves the cursor over a desired icon, such as an internet link, the user may exert additional pressure to open or activate that link. Exerting additional pressure may be ergonomically more appealing, smoother, and easier than clicking a button or double clicking a mouse pad, for example.

An additional operational advantage of the resonator pads is that they are not affected by water and other fluids on the control or touch surface. This is in stark contrast to conventional capacitive sensors.

Embodiments of the present invention use trapped energy resonators/acoustic wave cavities for rugged, sealed, pressure sensitive cursor control in metals, ceramics and plastics. The sliding sensors may be used to set and vary lighting, appliance heating elements, electronic devices, and the like. Certain embodiments of the present invention may be used, for example, as mouse touch pads for laptop computers.

While various spatial terms, such as upper, lower, mid, lateral, horizontal, vertical, and the like may used to describe portions of the embodiments discussed above, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A touch pad assembly comprising:
a substrate; and
a plurality of acoustic wave switches positioned with respect to said substrate, each of said plurality of acoustic wave switches comprising a touch surface connected to an acoustic wave cavity and a transducer secured to said acoustic wave cavity, said plurality of acoustic wave switches being positioned to provide detection of sliding motion direction and rate between said plurality of acoustic wave switches.

2. The touch pad assembly of claim 1, wherein said plurality of acoustic wave switches are oriented in a linear fashion.

3. The touch pad assembly of claim 1, wherein said plurality of acoustic wave switches are arranged in a circle.

4. The touch pad assembly of claim 1, wherein said plurality of acoustic wave switches are arranged in a plurality of rows.

5. The touch pad assembly of claim 1, wherein said plurality of acoustic wave switches are arranged in rows and columns on said substrate, wherein said rows and columns intersect to form said touch surfaces.

6. The touch pad assembly of claim 1, wherein said plurality of acoustic wave switches comprises four acoustic wave switches arranged as a cross.

7. The touch pad assembly of claim 1, wherein adjacent acoustic wave switches are spaced close enough together so that a finger tip touches both at the same time during operation.

8. The touch pad assembly of claim 1, wherein said plurality of acoustic wave switches distinguish between varying touch pressures.

9. The touch pad assembly of claim 1, wherein said transducer generates an acoustic wave that is trapped in said acoustic wave cavity.

10. The touch pad assembly of claim 9, wherein a touch on said touch surface produces a detectable change in the impedance of said transducer.

11. The touch pad assembly of claim 9, wherein a touch on said touch surface absorbs acoustic wave energy from the acoustic wave generated in said acoustic wave cavity by said transducer, and wherein a time decay of said acoustic wave is correlated to an amount of pressure exerted on said touch surface.

12. A touch pad system comprising:
a sensing device;
a substrate; and
a plurality of acoustic wave switches positioned with respect to said substrate, each of said plurality of acoustic wave switches comprising a touch surface connected to an acoustic wave cavity and a transducer secured to a side of said acoustic wave cavity opposite said touch surface, said sensing device being in communication with said transducer, said plurality of acoustic wave switches being positioned to provide detection of sliding motion direction and rate between said plurality of acoustic wave switches, wherein adjacent acoustic wave switches are positioned close enough with respect to one another that a finger tip touches both at the same time during operation.

13. The touch pad system of claim 12, wherein said sensing device is one or both of a processing unit and/or a sensing circuit.

14. The touch pad system of claim 12, wherein said plurality of acoustic wave switches are oriented in a linear fashion.

15. The touch pad system of claim 12, wherein said plurality of acoustic wave switches are arranged in a circle.

16. The touch pad system of claim 12, wherein said plurality of acoustic wave switches are arranged in a plurality of rows.

17. The touch pad system of claim 12, wherein said plurality of acoustic wave switches are arranged in rows and columns on said substrate, wherein said rows and columns intersect to form said touch surfaces.

18. The touch pad system of claim 12, wherein said plurality of acoustic wave switches comprises four acoustic wave switches arranged as a cross, wherein a finger overlays a portion of each of said four acoustic wave switches during operation.

19. The touch pad system of claim 12, wherein said sensing device receives signals from said plurality of acoustic wave switches such that varying touch pressures are capable of being distinguished.

20. The touch pad system of claim 12, wherein said transducer generates an acoustic wave that is trapped in said acoustic wave cavity.

21. The touch pad system of claim 20, wherein said sensing device detects a touch on said touch surface through a detectable change in the impedance of said transducer.

22. The touch pad system of claim 20, wherein said sensing device detects a touch on said touch surface that absorbs acoustic wave energy from the acoustic wave generated in said acoustic wave cavity by said transducer, and wherein a time decay of said acoustic wave is correlated to an amount of pressure exerted on said touch surface.

23. A touch pad system comprising:
one or both of a processing unit and/or a sensing circuit;
a substrate; and
a plurality of acoustic wave switches positioned with respect to said substrate, each of said plurality of acoustic wave switches comprising a touch surface connected to an acoustic wave cavity and a transducer secured to a side of said acoustic wave cavity opposite said touch surface, said transducer generating an acoustic wave that is trapped in said acoustic wave cavity, said transducer being in communication with one or both of said processing unit and/or said sensing circuit, said plurality of acoustic wave switches being positioned to provide detection of sliding motion direction and rate between said plurality of acoustic wave switches, one or both of said processing unit and/or said sensing device receiving signals from said plurality of acoustic wave switches such that varying touch pressures are capable of being distinguished, wherein adjacent acoustic wave switches are positioned close enough with respect to one another that a finger tip touches both at the same time during operation.

24. A touch pad system comprising:
one or both of a processing unit and/or a sensing circuit; and
first and second acoustic wave switches, wherein said first and second acoustic wave switches are spaced from one another such that a finger may contact both of said first and second acoustic wave switches simultaneously, and wherein said one or both of said processing unit and/or said sensing circuit recognizes a touch on said first acoustic wave switch as a first value, a touch on said second acoustic wave switch as a second value, and a touch on both of said first and second acoustic wave switches simultaneously as a third value.

25. The touch pad system of claim 24, wherein said first, second and third values are correlated to a position of a finger on the touch pad system.
